(19) United States
(12) Patent Application Publication
(10) Pub. No.: US 2004/0122580 A1
(43) Pub. Date: Jun. 24, 2004

(54) Method and apparatus for determining road conditions

(76) Inventor: Giles K. Sorrells, Metamora, IL (US)

Correspondence Address: CATERPILLAR INC., 100 N.E. ADAMS STREET, PATENT DEPT., PEORIA, IL, 616296490

(21) Appl. No.: 10/328,225

(22) Filed: Dec. 23, 2002

(51) Int. Cl. G06F 19/00

(52) U.S. Cl. 701/80; 701/50; 73/105

(57) ABSTRACT

This invention relates to a method and apparatus for determining road conditions base on monitoring a plurality of parameters of a machine system. The machine system includes a payload system, an engine control system, a transmission system and an accelerometer. A control module monitors the machine systems and estimates the torque output of a drivetrain. By analyzing data from the systems the control module can determine if the machine is being operated on road that is in need of repair and dispatch equipment to repair the road.

### TECHNICAL FIELD

This invention relates generally to a work machine and more specifically to a method of determining road conditions using operating parameters related to a plurality of machine systems.

### BACKGROUND

Work machines such as those used in large mining operations, are used to transport large amounts of material about a mine site. Because the cost of owning and operating such work machines is very high, it is beneficial to control cost related to machine operation. One way to maximizing machine life, minimizing repair costs and minimizing downtime, is by monitoring and maintaining road conditions.

Unlike permanent roads used by vehicles traveling about and between cities, mine roads are constructed quickly and tend to require a high degree of maintenance. The mine roads are extremely susceptible to damage from the large forces exerted on the road by the tires of the machines. Adverse road conditions that can drive up expenses related to operating the machines include soft underfoot conditions, steep grades and potholes. Soft underfoot conditions may reduce cycle times of the machines and increase stress on the drive train of the machine beyond an acceptable limit. Steep grades reduce cycle time when the machines are traveling up the grade, and may cause excessive wear to brake systems when the machine travels down the grade. Potholes may damage the machine structure or suspension.

Additionally, operator performance is another factor that increases overall operating expense of the machine. Examples of operator performance that may damage the machine include hard braking and aggressive steering. Under typical circumstances it is difficult to determine whether machine problems were caused by road conditions of operator performance.

U.S. Pat. No. 5,531,122 owned by Caterpillar Inc. of Peoria, Ill., the assignee of the present invention, provides a system for analyzing stresses on the structure of a machine by monitoring the pressure in a plurality of suspension struts. The system notifies the operator of an “event” after a predetermined limit has been exceed. The operator is then expected to determine what caused the event, such as hitting a pothole, and avoid repeating the cause of that event. It would be desirable to notify the machine operator the machine is approaching a section of bad road prior to an event happening.

A second patent owned by Caterpillar Inc., U.S. Pat. No. 5,848,371 provides a method for estimating torque of a drive train based on a computer model. This patent senses a plurality of parameters of the powertrain, including the driveline and engine parameters and produces a torque signal based on a predetermined model. The torque signal can be compared to a series of previously stored torque values to predict failure of driveline components. Although this method may be helpful in predicting component failure, a system for determining and eliminating causes of component failures is desired.

The present invention is directed to overcoming one or more of the above stated problems.

### SUMMARY OF THE INVENTION

In one aspect of the present invention a work machine having a frame, an engine and a final drive assembly is adapted to move the machine about a road. The machine includes a road analysis system having a plurality of machine systems adapted to transmit sensor data related to machine operating parameters. A main control module is adapted to receive the sensor data and a processor analyzes the sensor data to determine the condition of the road.

In another aspect of the present invention a method for determining the condition of a road is provided. The method includes the operating a work machine on the road, monitoring the operating parameters of machine systems, comparing the operating parameters to at least one predetermined value and determining that at least one of said operating parameters is beyond the predetermined value, representing an adverse condition of said road.

### BRIEF DESCRIPTION OF THE DRAWINGS

FIG. 1 is an elevation view of a work machine having the present invention.

FIG. 2 is a schematic representation of a control system of the work machine of FIG. 1 adapted to use the present invention.

### DETAILED DESCRIPTION

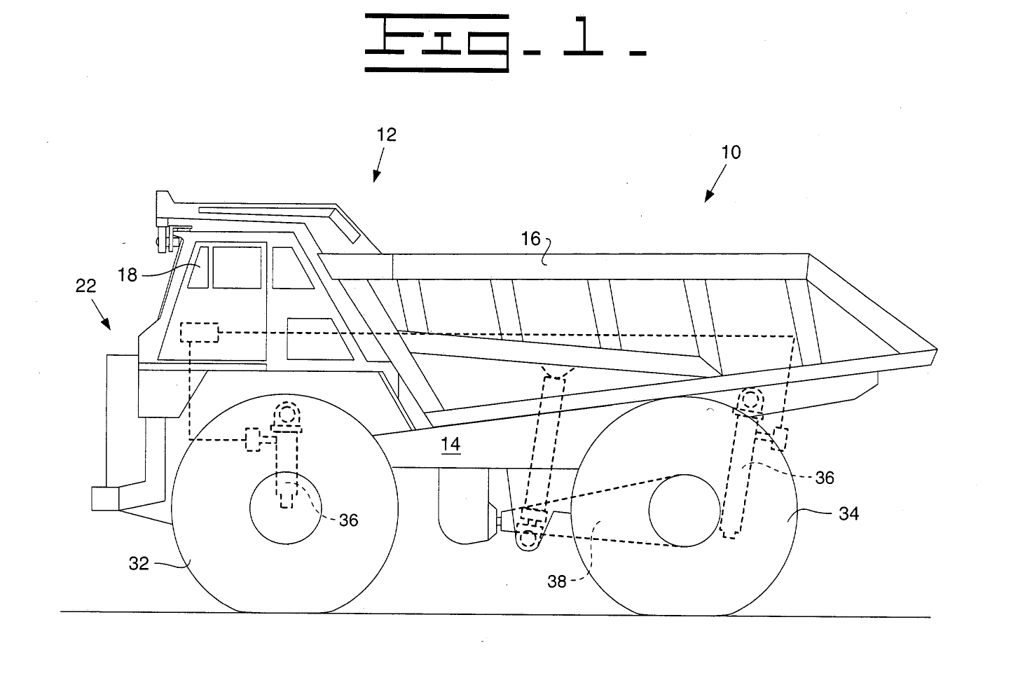

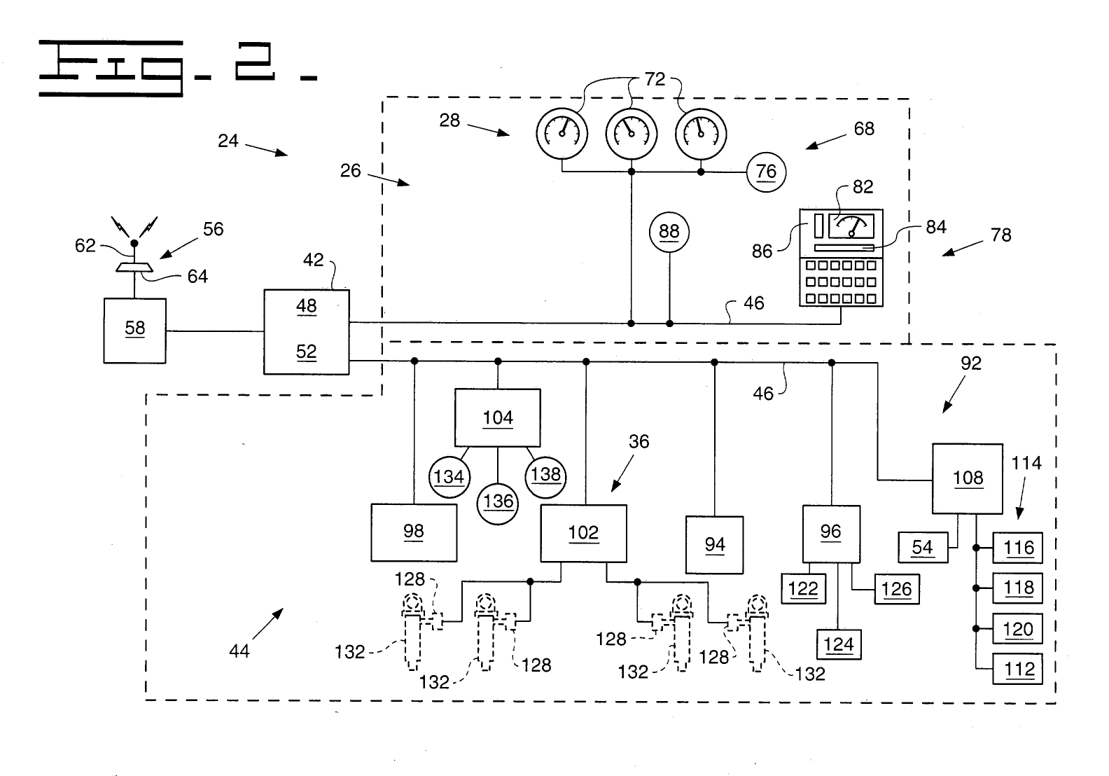

Referring now to FIG. 1, one example of a work machine 10 is an off-highway truck 12. The off-highway truck 12 is used to move material from the about a mine site. The truck 12 comprises a frame 14 and a dump body 16 pivotally mounted to the frame 14. An operator cab 18 is mounted on the front of the frame 14 above an engine enclosure 22. The truck 12 includes a control system 24 (shown in FIG. 2) having a plurality of inputs 26 and displays 28. The truck 12 is supported on the ground by a pair of front tires 32 (one shown), and a pair of driven rear tires 34 (one shown) at the rear of the truck. A suspension system 36 is positioned between the tires 32, 34 and frame 14 to dampen movement of the truck 12 as it travels over rough terrain. As well known in the art, one or more engines (not shown) are housed within the engine enclosure 22. The engine is used to provide power to a final drive assembly 38, via a mechanical or electric drive train.

Referring to FIG. 2, the control system 24 includes a main control module 42. The main control module 42 is electrically connected to a plurality of machine systems 44 via a data link 46. The main control module 42 includes a processor portion 48 and a memory portion 52. The memory portion 52 provides a storage location for programming and other electronic data. The processor 48 compares electronic data from a plurality of machine sensors 54 with a plurality of predetermined limits. The main control module 42 is also adapted to record events when sensor data is beyond the predetermined limits. Events can be categorized as a machine event or a system event. Machine events occur when the work machine 10 is being operated outside of normal limits. System events occur when self-diagnostic capabilities of the main control module 42 determine that the work machine 10 has a faulty electronic component.

The main control module 42 utilizes a radio system 56 to communicate with the remote office (not shown) and other work machines 10. An onboard GPS system 58 comprising an antenna 62, receiver 64 and processor 66 interface the main control module 42. The onboard GPS system 58 tracks the position of the work machine 10 in relation to a site map. The site map is stored in electronic form in the memory portion 52 or remote office. The position of the work machine 10 is relayed to the remote office via the main control module 42 and the radio system 56. At any given time the main control module 42 and the remote office can determine the location of the work machine 10 within ½ meter

The main control module 42 is also electrically connected to a plurality of monitoring devices 68 positioned in the operators cab 18. The plurality of monitoring devices 68 includes gauges 72, speedometer 74, tachometer 76 and a message center 78. The message center 78 is positioned in easy view of the operator and is adapted to relay information between the operator, main control module 42 and the remote office. The message center 78 provides a variety of machine system 44 data through a universal gage 82, and a digital display 84. An alert indicator 86 signals the operator of abnormal machine operating parameters. Additionally, an override switch 88 is provided in the operator's cab 18. The override switch 88 is electrically connected to main control module 42 and is configured to disable certain automatic functions of the main control module.

The plurality of machine systems 44 include, but are not limited to, an engine control system 92, a transmission control system 94, a brake control system 96, a steering system 98, a payload system 102 and a road analysis system 104. Numerous interface modules 106 are coupled between the main control module 42 and various machine systems 44 allowing transfer of data, via the data link 46.

The engine control system 92 includes and engine control module 108 electronically coupled to a plurality of engine components 110 and sensors 112. Engine components include a fuel system 114 having a fuel pump 116, fuel injectors 118, and a fuel control rack 120. The fuel pump supplies pressurized fuel to the fuel injectors 118 and the rack controls injection of the fuel into the engine. The engine sensors 112 are used for monitoring various engine-operating parameters. Engine operating parameters include, oil pressure, air temperature, coolant temperature, engine RPM and fuel injector 118 position. The engine control module 108 additionally sends signals to the engine related to desired engine speed.

The transmission control system 94 and controls a plurality of transmission operating parameters. Transmission operating parameters include gear lever position, gear selection, transmission oil temperature and torque converter speed. The main control module 42 receives data related to the transmission and engine parameters. From the engine and transmission parameters the main control module 42 can estimate torque output of the machine 10.

The brake control 96 monitors and controls a parking brake 122, a service brake 124 and an automatic retarder system 126. The parking brake 122 is automatically applied when the machine 10 is shut down and out of service. The service brake 124 is actuated by the operator in order to slow the machine 124. The automatic retarder system 126 actuates the service brake 124, or down shifts the transmission to slow the machine 10.

The payload system 102 includes a plurality of pressure transducers 128 connected to the suspension system 36. The suspension system 36 includes four struts 132 attached between the frame 14 and tires 32, 34 in a typical fashion. Each strut 132 connects to a pressure transducer 128 to monitor the pressure in the strut 132. The pressure transducer 128 relays a signal related to strut 132 pressure through an interface module 106 to the main control module 42. During static conditions, such as the machine 10 being parked and loaded, the main control module 42 uses each pressure signal to calculate actual weight distributed on each of the front and rear tires 32, 34. During dynamic conditions, when the machine 10 is moving about the mine site, the payload system 102 continually monitors strut 132 pressures to determine pitch and racking of the machine 10. Pitch and racking can further be used to estimate stresses induced on the frame 14. Pitch refers to a rocking force on the truck between the front and rear tires 32, 34. For example, a sudden application of the service brakes 124 during forward movement will cause a forward pitching motion. Rack refers to a twisting force on the frame of the machine due to uneven dynamic forces. An example of a pitching condition is when one tire is in a pothole and an opposite tire is on an incline. Pitch and rack may also be induced by operator performance, such as aggressive braking and turning. Road conditions such as potholes, uneven or rough surfaces and inclines also induce pitch and rack.

In a preferred embodiment, the road analysis system 104 includes a three-axis accelerometer 134 positioned on the machine 10 and electronically coupled to the main control module 42. The accelerometer 134 produces electronic signals related to the machines' 10 position and rate of change of position, related to each of a longitudinal axis, lateral axis and a vertical axis. The accelerometer 134 signals are transmitted to the main control module 42 through one the interface modules 106 and compared to strut 132 pressure signals to validate or improve the pitch and rack data. In addition to the accelerometer 134, a vibration meter 136 and inclinometer 138 may be electronically coupled to the main control module 42. Signals from the inclinometer 138 can be used to determine if the machine 10 is traveling on level ground, up an incline or down an incline. The vibration meter 132 provides a supplemental signal related to impacts on the machine 10 during loading and traveling on rough roads.

### Industrial Applicability

In operation the present invention provides an improved system for determining the condition of roads. The main control module monitors 42 engine and drive train parameters to produce an estimate of torque output to the final drive 38. Data from the GPS system 58, payload system 102 and road analysis system 104 is monitored to determine precise location of the machine, pitch, rack and impacts. Should any parameter or combination of parameters exceed a specific predetermined value, an event is be logged. Events may be categorized as different levels, for example, category one, category two or category three, of which category three being the most severe.

Events related to rack, pitch and torque can be analyzed separately or in combination to determine adverse road conditions. As a machine 10 travels along a road, an event caused by hitting a pothole may first show a spike in strut 132 pressure. The main control module 42 further evaluates data from at least one of the inclinometer 138, vibration meter 136, and accelerometer 134 to verify the severity of the event. Additionally, using the GPS system 58 the location and severity of the event can be recorded by at least one of the main control module 42 or remote office. As other machines 10 pass over an event location, it would be expected that more events are recorded by other machines. Also, if the event was cause by a pothole, it would be expected that the severity of the event would increase, as the pothole becomes enlarged. The site map can now be updated either manually or automatically to show an adverse road condition. As machines 10 travel the road and approach a known adverse road condition, a warning may be relayed to the machine operator, prior to an event and instructions can be displayed on the message center 78, advising the operator of an appropriate corrective measure to prevent another event. The computer at the remote office may additionally be programmed to dispatch instructions to a maintenance machine 10 for correcting the adverse condition. For example, a motorgrader may be sent to the location of the adverse condition and instructed to fill the pothole, or smooth the road.

Another example for using the present invention, the cycle time and speed of the machines moving about the mine site is monitored by at least one of the control module 42 and remote office. If the cycle time or speed of the machine falls below a predetermined value, an event is triggered. By analysis one or more of signals from the inclinometer, accelerometer or estimated torque output, road condition may be determined. For example, if torque is high the slope of the road can be determined using accelerometer, inclinometer or GPS position. If torque is higher than expected for the slope, soft underfoot conditions are the likely cause. High torque and slope signals indicates that the road is steeper than the machine is designed to be used on. In this case the remote office should dispatch equipment and reduce the slope of the road. In determining slope, the weight of the payload may also be considered. If the truck is loaded beyond capacity, a high torque reading may be expected.

In another example, poor operator techniques may be determined. Higher than expected signals related to pitch, roll may be observed on a single machine, while other machines show normal readings in the same locations. The machine having high readings may be representative of aggressive steering or failure to avoid obvious road hazards. The computer at the remote office may be programmed to deliver a warning to the operator or a supervisor. Mine managers may then determine the need for increased training of a particular operator. Alternatively, it may be determined that a machine system 44 is not functioning properly and the machine 10 requires repair.

Through monitoring existing and new machine systems, management of a fleet of work machines 10 may be automated. The present invention could be adapted to vehicles traveling about municipal roads, as some of the above-described technologies are adapted to the automotive market.

What is claimed is:

1. A work machine having a frame, an engine and a final drive assembly adapted to move said machine about a road, said machine including a road analysis system comprising:
a plurality of machine systems adapted to transmit sensor data related to a plurality of machine operating parameters;
a main control module adapted to receive sensor data; and
a processor adapted to analyze said sensor data and determine the condition of the road.

2. The work machine of claim 1, wherein said processor analyses data from at least one of an inclinometer, an accelerometer and a vibration monitor.

3. The work machine of claim 1, wherein said processor is adapted to estimated torque output of a final drive assembly in determining the condition of said road.

4. The work machine of claim 1, wherein said main control module notifies a remote office of an adverse road condition.

5. The work machine of claim 4, wherein one of said main control module and said remote office dispatches a work machine to the location of said adverse road condition for the purpose of correcting said adverse road condition.

6. The work machine of claim 1, wherein one of said main control module and said remote office notifies said machine operator that said machine is approaching a portion of a road having an adverse road condition.

7. A road analysis system comprising:
a plurality of machine systems adapted to transmit data related to a plurality of parameters of a plurality of machine systems;
a main control module adapted to receive said data; and
a processor portion adapted to analyze said data and determine the condition of the road.

8. The road analysis system of claim 7, wherein said processor analyses data from at least one of an inclinometer, an accelerometer and a vibration monitor.

9. The road analysis system of claim 7, wherein said processor calculates an estimated torque output of a final drive assembly in determining the condition of said road.

10. The road analysis system of claim 7, wherein said main control module signals a remote office of an adverse road condition.

11. The work machine of claim 10, wherein one of said main control module and said remote office dispatches a work machine to the location of said adverse road condition for the purpose of correcting said adverse road condition.

12. The work machine of claim 7, wherein one of said main control module and said remote office notifies said machine operator that said machine is approaching a portion of a road having an adverse road condition.

13. A method for determining the condition of a road, said method comprising the steps of:
operating a work machine on said road;
monitoring the operating parameters of a plurality machine systems of said work machine;
comparing the operating parameters to at least one predetermined value; and
determining that at least one of said operating parameters is beyond said predetermined value, representing an adverse condition of said road.

14. The method of claim 13, including the step of notifying a remote of said adverse road condition.

15. The method of claim 13, including the step of monitoring the location of said work machine on said road.

16. The method of claim 15, including the step of notifying an operator of said work machine that said work machine is approaching said adverse road condition.

17. The method of claim 15, including the step of causing said work machine to slow down prior to reaching said portion of said road have said adverse condition.

18. The method of claim 13, dispatching a work machine to said location of said adverse road condition for the purpose of repairing said road.

19. The method of claim 13, including the step of determining that determining that said at least one of said operating parameters being beyond said predetermined value is caused by a performance of said machine operator.
